(19) United States
(12) Patent Application Publication
(10) Pub. No.: US 2007/0268593 A1
(43) Pub. Date: Nov. 22, 2007

(54) Projecting lens device and optical engine having the same

(75) Inventors: Byung-jo Kang, Suwon-si (KR); Heong-seog Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/586,509

(22) Filed: Oct. 26, 2006

(30) Foreign Application Priority Data
May 18, 2006 (KR) 2006-44805

(51) Int. Cl. G02B 3/00

(52) U.S. Cl. 359/649

(57) ABSTRACT

A projecting lens device includes a first projecting lens system which enlarges and projects an incident image and light onto a projection plane, a second projecting lens system which guides an image generated by an image generator and the light of an illumination system to the first projecting lens system, and a main lens barrel and a sub lens barrel in which the first projecting lens system and the second projecting lens system are installed. The main lens barrel is made of a thermally conductive material such as aluminum, the sub lens barrel is disposed in the rear of the main lens barrel, and a heat prevention member is disposed between the main lens barrel and the first projecting lens system.

### CROSS-REFERENCE TO RELATED APPLICATIONS

This application claims the benefit under 35 U.S.C. § 119 (a) of Korean Patent Application No. 2006-44805, filed on May 18, 2006, the entire contents of which are hereby incorporated by reference.

### BACKGROUND OF THE INVENTION

1. Field of the Invention

The present invention relates to a projecting lens device of a projection system, and an optical engine having the same. More particularly, the present invention relates to a projecting lens device which effectively withstands heat, and an optical engine having the same.

2. Description of the Related Art

Generally, a projection system projects an image onto a projection plane such as a screen and produces a large, high definition image. Projection systems include projectors, projection televisions, and the like. Projection systems may be classified as cathode ray tube (CRT) projection systems, liquid crystal display (LCD) projection systems, and digital light processing (DLP) projection systems, depending on the type of display device used to produce an image.

The CRT projection system has been in use for the longest time. This system reflects a small-sized cathode ray tube on a mirror to form a screen image. In an LCD projection system, an external reproduction image signal is transmitted to a projection TV. A small-sized LCD screen, which has a diameter of approximately 4 inches and is disposed in the projection TV, receives the signal to reproduce an image. Then, a strong light beam is projected onto the image from the rear of the LCD screen so that the image is enlarged, reflected by a mirror, and projected on a screen. The DLP projection system uses a digital micro-mirror device assembly, in which hundreds of thousands of micro mirrors are integrated, to enlarge and project an image signal received from the outside.

An optical engine of the projection system comprises an illumination system which generates light, an image generator which forms an image using the light generate by the illumination system, and a projecting lens device which projects the image generated by the image generator on a projection plane such as a screen.

The illumination system comprises a light source such as an illumination lamp which generates light, and a light tunnel which guides the generated light to the image generator.

The image generator comprises a display device such as a liquid crystal display (LCD), a liquid crystal on silicon (LCos), or a digital micromirror device (DMD), and the display device receives image information from the outside to generate a certain image.

The image generated by the image generator and the light guided by the illumination system are guided through a member such as a prism to the projecting lens device. The projecting lens device comprises a plurality of lenses which enlarge the guided image and light, and project the enlarged image and light onto a projection plane such as a screen.

The projecting lens device comprises a first projecting lens system which enlarges the incident image and light and projects the enlarged image and light, and a second projecting lens system which guides the image and light of the image generator to the first projecting lens system. The first and second projecting lens systems include at least one projecting lens, and are provided in a lens barrel.

The lens barrel is made of a thermally conductive metal material to effectively emit heat generated by the light passing the first and second projecting lens systems to the outside.

In the conventional projecting lens system, the heat generated by the image generator and the illumination system can be transmitted through the thermally conductive lens barrel to the projecting lens. The projecting lens may be deformed by the transmitted heat.

The thermal deformation contracts or expands the lens barrel and/or the projecting lens so that external force or stress exerted on a portion where the lens barrel is in contact with the projecting lens and the external force or stress causes the projecting lens to be damaged or cracked. Accordingly, the lifespan of the projecting lens device may be shortened.

Accordingly, there is a need for an improved projecting lens device that effectively protects a projecting lens from heat, and an optical engine having the same.

### SUMMARY OF THE INVENTION

An aspect of the present invention is to address at least the above problems and/or disadvantages and to provide at least the advantages described below. Accordingly, an aspect of the present invention is to provide a projecting lens device that can effectively protect a projecting lens, and an optical engine having the same.

Another aspect of the present invention is to provide a projecting lens device that can project a projecting lens from heat and easily emit heat, and an optical engine having the same, wherein the heat is generated in the optical engine itself or by light passing through a projecting lens system.

In accordance with an exemplary embodiment of the present invention, there is provided a projecting lens device including: one or more projecting lens, a lens barrel in which the projecting lens is provided, and a heat prevention member which is disposed between the projecting lens and the lens barrel.

In accordance with an exemplary embodiment of the present invention, there is provided a projecting lens device including a first projecting lens system which projects an image and light onto a projection plane and has one or more first projecting lens, a second projecting lens system which receives the image and the light to guide the received image and light to the first projecting lens system, and has one or more second projecting lens, a lens barrel in which the first projecting lens system and the second projecting lens system are installed, and a heat prevention member which is disposed between the lens barrel and one or more the first projecting lens of the first projecting lens system.

The heat prevention member may be made of a material that has lower thermal conductivity than a material of the lens barrel.

The heat prevention member may be made of a thermal insulating material.

The heat prevention member may be configured as a ring-shaped structure.

The heat prevention member may be configured as a corrugated ring-shaped structure.

In accordance with an exemplary embodiment of the present invention, there is provided a projecting lens device including a main lens barrel in which one or more first projecting lens is installed, a sub lens barrel in which one or more second projecting lens is installed, and one or more first heat prevention member which is disposed between the first projecting lens and the main lens barrel.

The projecting lens device may further include one or more second heat prevention member that is disposed between the second projecting lens and the sub lens barrel.

The heat prevention members may be made of a material that has a lower thermal conductivity than a material of the main lens barrel and the sub lens barrel.

The heat prevention members may be made of a thermal insulating material.

The heat prevention members may be configured as ring-shaped structures.

The first and second heat prevention members may be configured as corrugated ring-shaped structures.

To achieve an object of the present invention, there is provided an optical engine including an illumination system which generates light, an image generator which forms an image, and a projecting lens device which projects the image of the image generator and the light of the illumination system onto a projection plane, and includes one or more projecting lens, a lens barrel in which the projecting lens is installed, and a heat prevention member which is disposed between the projecting lens and the lens barrel. Another aspect of the present invention provides a display device, comprising: a screen; an illumination system that generates a light and emits the generated light; an image generator that generates an image using the light emitted from the illumination system; and a projecting lens device that projects the image generated by the image generator onto the screen, wherein the projecting lens device comprises at least one projecting lens, a lens barrel having the projecting lens, and a heat prevention member interposed between the projecting lens and the lens barrel.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 schematically illustrates a display device according to an exemplary embodiment of the present invention;

FIG. 2 is a perspective view of an optical engine according to an exemplary embodiment of the present invention;

FIG. 3 is an exploded perspective view of a projecting lens device according to an exemplary embodiment of the present invention;

FIG. 4 is a sectional view of a projecting lens device according to an exemplary embodiment of the present invention;

FIG. 5 is a sectional view of the projecting lens device taken on line IV-IV of FIG. 4; and

FIG. 6 is a sectional view of an alternative exemplary embodiment of the projecting lens device of FIG. 5.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention and are merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

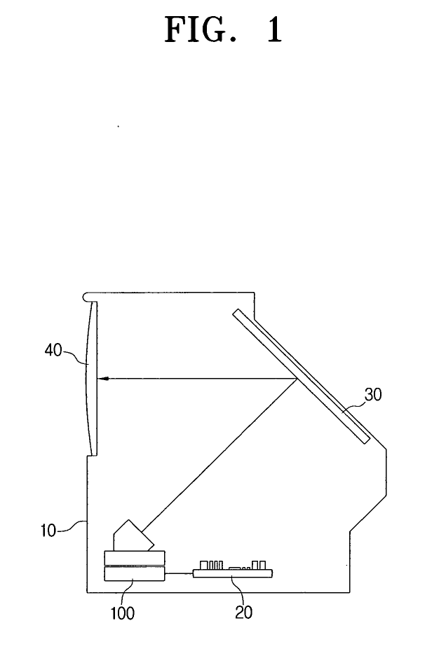

FIG. 1 schematically illustrates a display device according to an exemplary embodiment of the present invention.

As shown, the display device according to an exemplary embodiment of the present invention comprises a main body casing 10 which forms the overall appearance of the display device, a screen 40 mounted to a front of the main body casing 10, reflective mirror 30 mounted inside the rear portion of the main body casing 10, an optical engine 100 housed in the lower portion of the main body casing 10 to emit image beam toward the reflective mirror 30, and a circuit portion 20 to drive the optical engine 100.

The display device constructed as explained above accordingly forms an image beam at the optical engine 100 by the circuit portion 20, and the image beam is emitted to the reflective mirror 30, passes the reflective mirror 30, and falls onto the screen 40 to form a corresponding image.

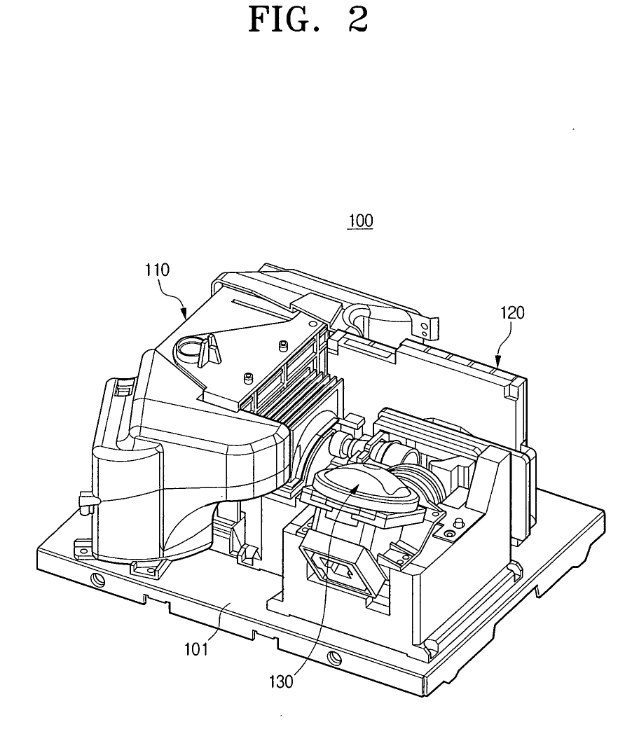

FIG. 2 is a perspective view of an optical engine according to an exemplary embodiment of the present invention.

An optical engine 100 according to an exemplary embodiment of the present invention comprises a base 101, an illumination system 110 which generates light, an image generator 120 which forms an image using the light generated by the illumination system 110, and a projecting lens device 130 which projects the image generated by the image generator 120 onto a projection plane such as a screen.

The illumination system 110 comprises a light source such as an illumination lamp which generates light, and a light tunnel which guides the generated light to the image generator 120.

The image generator 120 comprises a display device such as a liquid crystal display (LCD), a liquid crystal on silicon (LCos) chip, or a digital micromirror device (DMD). The display device receives image information from an external source to generate a certain image.

The image generated by the image generator 120 and the light guided by the illumination system 110 are guided through a prism member or a reflecting system to the projecting lens device 130. The projecting lens device 130 enlarges the guided image and light and projects the enlarged image and light onto a projection plane such as a screen.

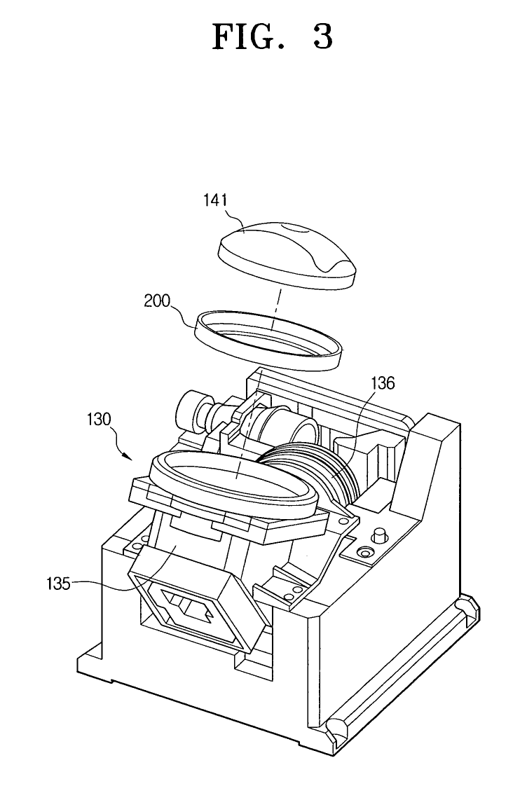

FIGS. 3 through 6 illustrate the projecting lens device according to an exemplary embodiment of the present invention.

The projecting lens device 130 comprises a first projecting lens system 140 which enlarges and projects the incident image and light onto a projection plane, a second projecting lens system 150 which guides the image of the image generator 120 and the light of the illumination system 110 to the first projecting lens system 140, and a main lens barrel 135 and a sub lens barrel 136 in which the first and second projecting lens systems 140 and 150 are installed. The main lens barrel 135 is made of a thermally conductive material, and the sub lens barrel 136 is disposed in the rear of the main lens barrel 135.

A reflecting system 160 is disposed between the first projecting lens system 140 and the second projecting lens system 150, and an iris (not shown) may be disposed at one or both of the first projecting lens system 140 and the second projecting lens system 150.

The first projecting lens system 140 is disposed in the main lens barrel 135 and comprises one or more the first projecting lens 141, 142, and 143.

FIG. 3 illustrates a heat prevention member 200 that is disposed between the first projecting lens 141, which is provided at the outermost among the plurality of the first projecting lenses 141, 142, and 143, and the main lens barrel 135.

The heat prevention member 200 is made of a material such as synthetic resin, which has a lower thermal conductivity than the material of the main barrel 135, or a thermal insulating material. Accordingly, the heat prevention member 200 can minimize the transmission of heat from the thermally conductive main barrel 135 to reduce the amount of external forces or stress generated by thermal distortion of the main lens barrel 135 and/or the projecting lens 141 at the connection between the main lens barrel 135 and the projecting lens 141. Thus, cracks or other damage to the projecting lens 141 can be prevented.

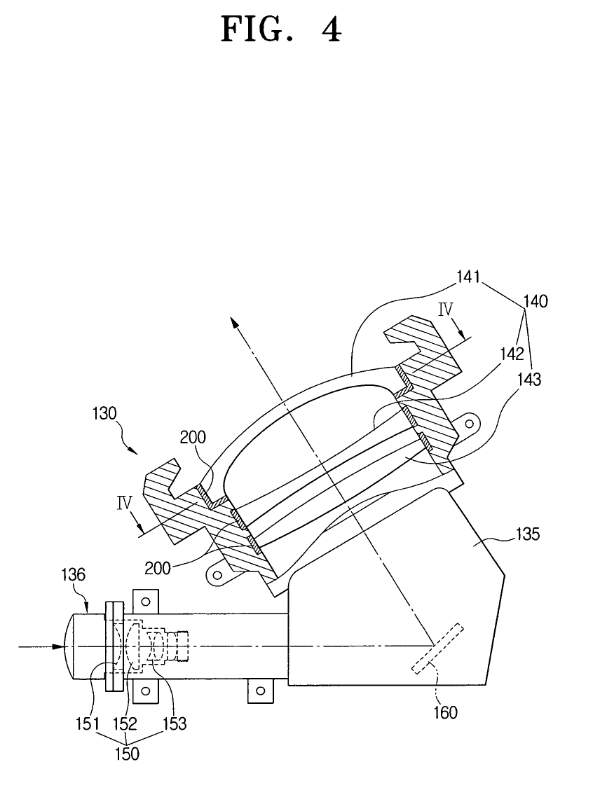

If the first projecting lens system 140 includes a plurality of first projecting lenses 141, 142, and 143, the heat prevention member 200 may be disposed between each of the first projecting lenses 141, 142, and 143 and the main lens barrel 135, as shown in FIG. 4.

The second projecting lens system 150 is disposed in the sub lens barrel 136, and may be movable with respect to the main lens barrel 135 to adjust the image focus.

The second projecting lens system 150 comprises one or more second projecting lenses 151, 152, and 153, and a heat prevention member (not shown) may be disposed between the sub lens barrel 136 and the second projecting lenses 151, 152, and 153 like the first projecting lens system 140. The projecting lenses of the first and second projecting lens systems 140 and 150 may be made of various materials, such as optical glass, optical plastic, or a mixture of optical glass and optical plastic, and the lenses may be spherical lens or aspherical lens.

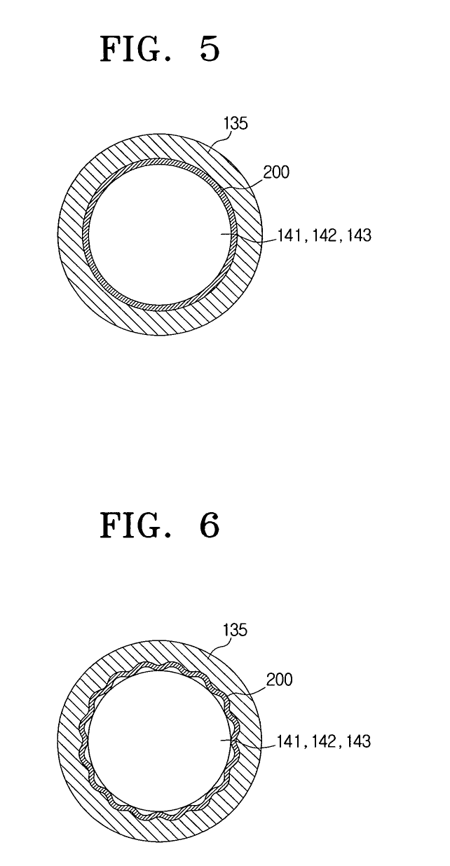

The heat prevention member 200 may be configured as a ring-shaped structure disposed between the main lens barrel 135 and the projecting lenses 141, 142, and 143, as shown in FIG. 5.

Alternatively, the heat prevention member 200 may be configured as a corrugated ring-shaped structure, as shown in FIG. 6.

The heat prevention member 200 can protect the projecting lenses 141, 142, 143, 151, 152, and 153 from receiving heat through the lens barrels 135 and 136. The heat may be generated by the illumination system 110 and the image generator 120 or by the light passing through the projecting lens device 130.

The heat prevention member 200 with a corrugated ring-shaped circumferential surface is particularly effective at reducing the external forces or stresses generated by thermal distortion between the projecting lenses 141, 142, 143, 151, 152, and 153 and the lens barrels 135 and 136.

Additionally, the projecting lenses 141, 142, 143, 151, 152 and 153 may be fit in the inner circumferential surface of the heat prevention member 200, and the heat prevention member 200 may be fit in the inner circumferential surface of the main lens barrel 135 and/or the sub lens barrel 136. Accordingly, the heat prevention member 200 allows the projecting lenses 141, 142, 143, 151, 152, and 153 to be closely fit in the lens barrels 135 and 135 so that the projecting lenses 141, 142, 143, 151, 152, and 153 can be firmly installed.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A projecting lens device comprising:
a lens barrel;
at least one projecting lens disposed in the lens barrel; and
a heat prevention member disposed between the projecting lens and the lens barrel.

2. The projecting lens device as claimed in claim 1, wherein the thermal conductivity of the heat prevention member is less than the thermal conductivity of the lens barrel.

3. The projecting lens device as claimed in claim 1, wherein the heat prevention member comprises a thermal insulating material.

4. The projecting lens device as claimed in claim 1, wherein the heat prevention member is ring-shaped.

5. The projecting lens device as claimed in claim 1, wherein the heat prevention member is a corrugated ring-shaped structure.

6. A projecting lens device comprising:
a lens barrel;
a first projecting lens system disposed in the lens barrel, the first projecting having at least one first projecting lens for projecting an image onto a projection plane;
a second projecting lens system disposed in the lens barrel, the second projecting lens system having at least one second projecting lens for receiving an image and guiding the image to the first projecting lens system; and
a heat prevention member disposed between the lens barrel and the at least one first projecting lens of the first projecting lens system.

7. The projecting lens device as claimed in claim 6, wherein the thermal conductivity of the heat prevention member is less than the thermal conductivity of the lens barrel.

8. The projecting lens device as claimed in claim 6, wherein the heat prevention member comprises a thermal insulating material.

9. The projecting lens device as claimed in claim 6, wherein the heat prevention member is ring-shaped.

10. The projecting lens device as claimed in claim 6, wherein the heat prevention member is a corrugated ring-shaped structure.

11. A projecting lens device comprising:
a main lens barrel having at least one first projecting lens;
a sub lens barrel having at least one second projecting lens; and
at least one first heat prevention member disposed between the at least one first projecting lens and the main lens barrel.

12. The projecting lens device as claimed in claim 11, further comprising at least one second heat prevention member disposed between the at least one second projecting lens and the sub lens barrel.

13. The projecting lens device as claimed in claim 12, wherein the thermal conductivities of the first and second heat prevention members are lower than the thermal conductivities of the main lens barrel and the sub lens barrel, respectively.

14. The projecting lens device as claimed in claim 12, wherein the first and second heat prevention members are made of a thermal insulating material.

15. The projecting lens device as claimed in claim 12, wherein the first and second heat prevention members are ring-shaped structures.

16. The projecting lens device as claimed in claim 12, wherein the first and second heat prevention members are corrugated ring-shaped structures.

17. An optical engine comprising:
an illumination system that generates light;
an image generator that forms an image; and
a projecting lens device that projects the image formed by the image generator and the light generated by the illumination system onto a projection plane, the projecting lens device including a lens barrel, at least one projecting lens disposed in the lens barrel, and a heat prevention member which is disposed between the projecting lens and the lens barrel.

18. The optical engine as claimed in claim 17, wherein the thermal conductivity of the heat prevention member is less than the thermal conductivity of the lens barrel.

19. The optical engine as claimed in claim 17, wherein the heat prevention member comprises a thermal insulating material.

20. The optical engine as claimed in claim 17, wherein the heat prevention member is ring-shaped.

21. The optical engine as claimed in claim 17, wherein the heat prevention member is a corrugated ring-shaped structure.

22. A projecting lens device comprising:
a lens barrel;
at least one projecting lens disposed in the lens barrel; and
means for preventing heat transfer between the projecting lens and the lens barrel.

23. The projecting lens device as claimed in claim 22, wherein the means for preventing heat transfer comprises a heat prevention member disposed between the projecting lens and the lens barrel.

24. The projecting lens device as claimed in claim 22, wherein the thermal conductivity of the means for preventing heat transfer is less than the thermal conductivity of the lens barrel.

25. The projecting lens device as claimed in claim 22, wherein the means for preventing heat transfer comprises a thermal insulating material.

26. The projecting lens device as claimed in claim 22, wherein the means for preventing heat transfer is ring-shaped.

27. The projecting lens device as claimed in claim 22, wherein the means for preventing heat transfer is a corrugated ring-shaped structure.

28. A display device, comprising:
a screen;
an illumination system that generates a light and emits the generated light;
an image generator that generates an image using the light emitted from the illumination system; and
a projecting lens device that projects the image generated by the image generator onto the screen, and comprises,
at least one projecting lens,
a lens barrel having the projecting lens, and
a heat prevention member interposed between the projecting lens and the lens barrel.

29. The display device as claimed in claim 28, wherein the thermal conductivity of the heat prevention member is less than the thermal conductivity of the lens barrel.

30. The display device as claimed in claim 28, wherein the heat prevention member comprises a thermal insulating material.

31. The display device as claimed in claim 28, wherein the heat prevention member is ring-shaped.

32. The display device as claimed in claim 28, wherein the heat prevention member is a corrugated ring-shaped structure.
